(19) United States
(12) Patent Application Publication
(10) Pub. No.: US 2008/0291264 A1
(43) Pub. Date: Nov. 27, 2008

(54) DIGITAL CAMERA FOR TV CONFERENCE

(75) Inventor: Motonari Chinuki, Chiba (JP)

Correspondence Address: HARNESS, DICKEY & PIERCE, P.L.C., P.O. BOX 828, BLOOMFIELD HILLS, MI, 48303, US

(73) Assignee: THE BANK OF TOKYO-MITSUBISHI UFJ, LTD., Tokyo (JP)

(21) Appl. No.: 11/938,987

(22) Filed: Nov. 13, 2007

(30) Foreign Application Priority Data
Mar. 26, 2007 (JP) 2007-2007

(51) Int. Cl. H04N 7/14

(52) U.S. Cl. 348/14.08; 348/E07.083

(57) ABSTRACT

There is provided an inexpensive digital camera for a TV conference used in a TV conference held between locations remote from each other with a large number of attendees on both sides to acquire an image of all the attendees. The digital camera 1 for a TV conference used in a TV conference held with a plurality of attendees to acquire an image of the plurality of attendees and operable to output the acquired image data includes a camera body 2 provided with an imaging element therein, a main lens unit 5 provided at the portion of the camera body 2 that corresponds to the imaging element, and a sub-lens unit 10 having a wide viewing angle attached to the front end of the main lens unit 5.

### BACKGROUND OF THE INVENTION

1. Field of the Invention

The present invention is applied when display devices, such as liquid crystal displays, are used to hold a TV conference between locations remote from each other with a large number of attendees on both sides, and relates to a digital camera for a TV conference suitable for acquiring images of attendees of the TV conference and displaying them on the display screens of the display devices.

2. Description of the Related Art

In recent years, there have been provided various TV conference systems using networks, and they have been widely used, for example, when panel display devices, such as liquid crystal monitors, are used to hold a TV conference between locations remote from each other with a large number of attendees on both sides.

In such a TV conference system, for example, the attendees are seated in a circle, and the display devices, such as liquid crystal displays, are placed in such a way that they face the attendees. Then, the attendees operate their keyboards, mouses and the like to participate in the TV conference.

By installing a surveillance camera on the ceiling or the like in the room, using the surveillance camera to acquire images of the attendees of the TV conference, and displaying the images on the display screens of the display devices, it is possible, for example, to know who is participating in the TV conference and make decisions through majority votes of the attendees on both sides remote from each other through the display screens of the display devices, thus allowing the TV conference to smoothly proceed.

However, such a surveillance camera is extremely expensive and requires complicated control, resulting in high cost as a whole for building the TV conference system.

On the other hand, such a surveillance camera can be replaced with a commercially available inexpensive digital camera. The digital camera is used to acquire images of the attendees of the TV conference and the acquired images can be displayed on the display screens of the display devices. However, since the lens built in such a commercially available camera has a narrow viewing angle, it is difficult to acquire an image of all the attendees and display the image on the display screens of the display devices. It is therefore difficult, for example, to clearly know who is participating in the TV conference and make decisions through majority votes of the attendees on both sides remote from each other (see the Logicool website (web camera) at <http://www.logicool.co.jp/index.cfm> on the Internet, particularly the one visited on Mar. 15, 2007).

### SUMMARY OF THE INVENTION

The present invention has been made in view of the conventional problems described above and aims to provide an inexpensive digital camera for a TV conference capable of acquiring an image of all attendees of the TV conference and displaying the image on the display screens of display devices.

To solve the above problems, according to the present invention, there is provided a digital camera for a TV conference used in a TV conference held with a plurality of attendees to acquire an image of the plurality of attendees and operable to output the acquired image data. The camera includes a camera body provided with an imaging element therein, a main lens unit provided at the portion of the camera body that corresponds to the imaging element, and a sub-lens unit having a wide viewing angle attached to the front end of the main lens unit.

According to the digital camera for a TV conference of the present invention, since the sub-lens unit having a wide viewing angle is attached to the front end of the main lens unit and the main-lens unit cooperates with the sub-lens unit to acquire images, the viewing angle for image acquisition can be increased.

Therefore, for example, when a TV conference is held with attendees seated in a circle, placing the digital camera for a TV conference according to the present invention at the center of the circle allows acquisition of an image of all the attendees.

To this end, the sub-lens unit having a wide viewing angle may be attached to a commercially available inexpensive digital camera, resulting in cost reduction.

In the present invention, the main lens unit may include a lens barrel and at least one lens provided in the lens barrel, and the sub-lens unit may be attached to the front end of the lens barrel.

According to the digital camera for a TV conference of the invention, for example, since the lens barrel of the main lens unit of a commercially available digital camera is used to attach the sub-lens unit, the sub-lens unit can be attached to the main lens unit without compromising functions of the main lens unit of the commercially available digital camera.

In the present invention, the sub-lens unit may include a lens barrel and a fish-eye lens provided at the front end of the lens barrel or in the lens barrel, and the lens barrel may be attached to the front end of the lens barrel of the main lens unit.

According to the digital camera for a TV conference of the invention, the sub-lens unit is attached to the main lens unit by attaching the lens barrel of the sub-lens unit to the lens barrel of the main lens unit. In this case, since the sub-lens unit has a fish-eye lens, the fish-eye lens can cooperate with the lens in the main lens unit to acquire an image of all the attendees of the TV conference.

Additionally, since the sub-lens unit has a simple configuration in which the fish-eye lens is attached to the front end of the lens barrel or in the lens barrel, the viewing angle of the main lens unit of the commercially available digital camera can be increased at a reasonable cost.

In the present invention, the main lens unit may further include a zooming mechanism that adjusts the focal length of the at least one lens and a focus adjustment mechanism that adjusts the focus of the at least one lens.

According to the digital camera for a TV conference of the invention, the zooming mechanism and the focus adjustment mechanism of the main lens unit allows adjustment of the size and sharpness of an image acquired through the sub-lens unit and the main lens unit.

In the present invention, the camera body may be provided with a supporting member that supports the camera body with the main lens unit facing upward.

According to the digital camera for a TV conference of the invention, the supporting member can support the camera body with the main lens unit facing upward.

As described above, in the digital camera for a TV conference according to the present invention, since the sub-lens unit having a wide viewing angle is attached to the front end of the main lens unit and the main-lens unit cooperates with the sub-lens unit to acquire images, the viewing angle for image acquisition can be increased.

Therefore, for example, when a TV conference is held with attendees seated in a circle, placing the digital camera for a TV conference according to the present invention at the center of the circle allows acquisition of an image of all the attendees. It is therefore possible, for example, to clearly know who is participating in the TV conference and make decisions through majority votes, thus allowing the TV conference to smoothly proceed.

To this end, the sub-lens unit having a wide viewing angle may be attached to the existing main lens unit of a commercially available inexpensive digital camera, resulting in cost reduction. Therefore, when the digital camera for a TV conference according to the present invention is applied to a TV conference system, the cost required for building the whole system can be reduced.

### BRIEF DESCRIPTION OF THE DRAWINGS

FIG. 1 is a perspective view showing the entire digital camera for a TV conference according to the present invention;

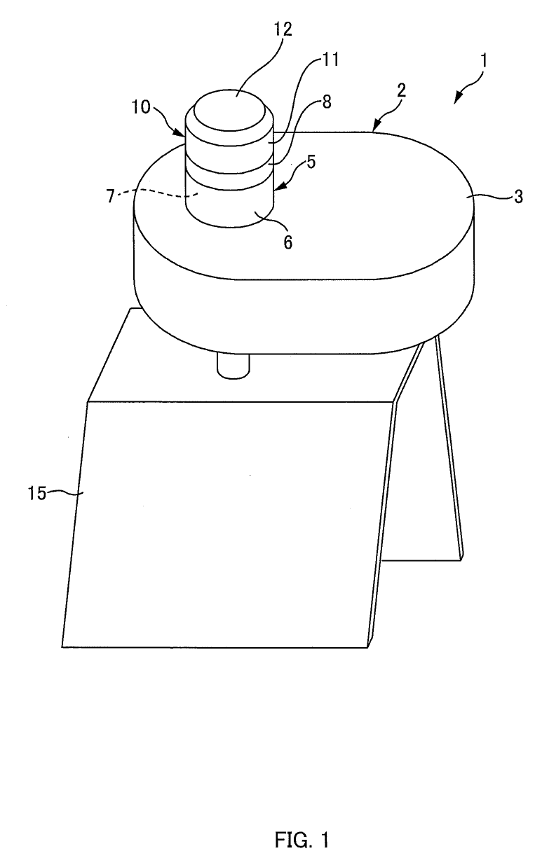

FIG. 2 is a schematic plan view showing the digital camera for a TV conference according to the present invention placed at the center of a circle along which attendees of the TV conference are seated; and

FIG. 3 is a front view taken in the direction A shown in FIG. 2.

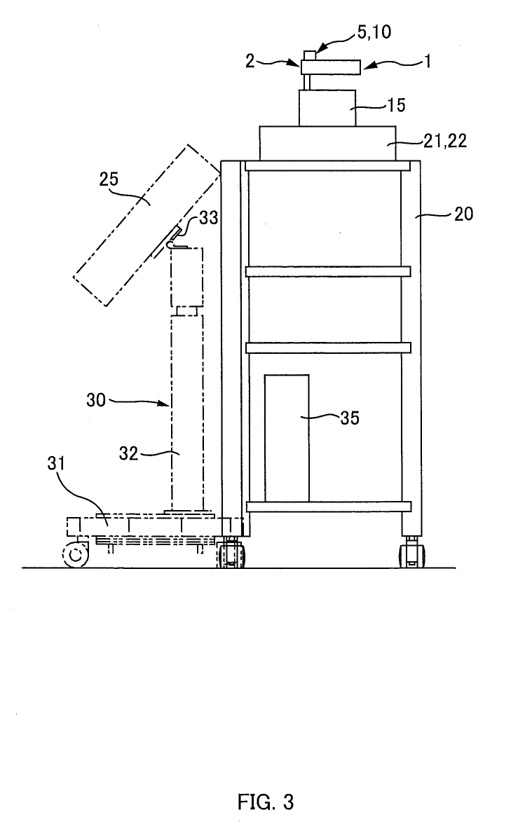

### DETAILED DESCRIPTION OF THE PREFERRED EMBODIMENTS

An embodiment of the present invention will be described below with reference to the drawings.

The digital camera 1 for a TV conference according to the present embodiment is applied to various TV conference systems using networks. For example, when panel display devices 25, such as liquid crystal monitors, are used to hold a TV conference between locations remote from each other with a large number of attendees on both sides, the digital camera 1 for a TV conference is effective in acquiring an image of all attendees 40 and displaying the image on the display screens of the display devices 25. The digital camera 1 includes a camera body 2, a main lens unit 5 attached to the camera body 2, and a sub-lens unit 10 attached to the main lens unit 5.

The camera body 2 includes a casing 3 and electronic components provided in the casing 3, such as a CPU, an imaging element (a CCD, for example), an AD converter, and a memory. The main lens unit 5 is attached to the portion of the casing 3 that corresponds to the image element.

The main lens unit 5 includes a tubular lens barrel 6 provided at the portion of the casing 3 that corresponds to the image element in such a way that the center line of the lens barrel 6 coincides with the center of the imaging element, and at least one lens 7 disposed in the lens barrel 6 in such a way that the optical axis of the lens 7 coincides with the center line of the lens barrel 6. The lens 7 in the main lens unit 5 and a fish-eye lens 12 in the sub-lens unit 10, which will be described later, cooperate to project an image of a subject (the attendees 40 of the TV conference) on the imaging element.

In the present embodiment, the main lens unit 5 further includes a zooming mechanism and a focus adjustment mechanism.

The zooming mechanism can adjust the total length of the lens barrel 6 so that the lens barrel 6 is extended or retracted in the optical axis direction to adjust the focal length of the lens 7 in the lens barrel 6. The focus adjustment mechanism includes, for example, a focus adjustment ring 8 provided at the front end of the lens barrel 6, and the focus adjustment ring 8 is manipulated to adjust the position of the lens 7 in the lens barrel 6. Use of the main lens unit 5 equipped with such zooming mechanism and focus adjustment mechanism allows adjustment of the size and sharpness of an image of a subject projected on the imaging element.

The main lens unit 5 may be equipped only with the focus adjustment mechanism.

The sub-lens unit 10 includes a cylindrical lens barrel 11 and a fish-eye lens 12 having a view angle of approximately 180 degrees, the fish-eye lens 12 provided at the front end of the lens barrel 11 or in the lens barrel 11 (at the front end in the present embodiment) in such a way that the center (optical axis) of the fish-eye lens 12 coincides with the center line of the lens barrel 11. The rear end of the lens barrel 11 is attached to the front end of the lens barrel 6 of the main lens unit 5 in such a way that the center line of the lens barrel 11 coincide with that of the lens barrel 6.

In the present embodiment, the length of the lens barrel 11 of the sub-lens unit 10 is not adjustable, so that the adjustment ring 8 of the main lens unit 5 is used to focus an image acquired through the sub-lens unit 10 and the main lens unit 5. Alternatively, the sub-lens unit 10 may be configured to perform focusing.

A supporting member 15 is removably attached to the side of the casing 3 of the camera body 2 opposite to the main lens unit 5. The supporting member 15 allows the digital camera 1 for a TV conference to be placed on a rack 20 with the main lens unit 5 facing upward. Depending on where the digital camera 1 for a TV conference is placed, the supporting member 15 may have a base-like shape or may be fixable with screws or the like.

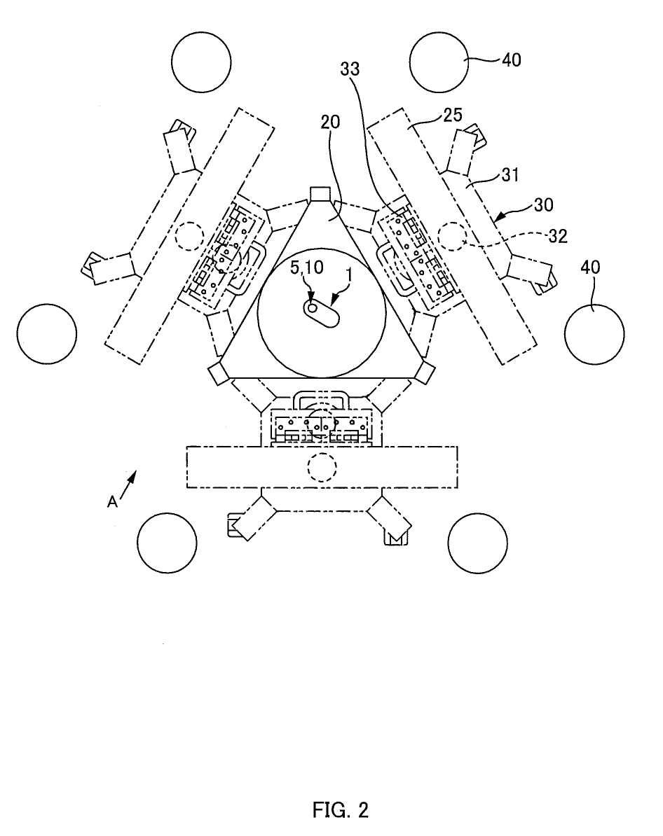

To hold a TV conference between locations remote from each other with a large number of attendees on both sides by using the digital camera 1 configured as described above and the panel display devices 25, such as liquid crystal monitors, for example, as shown in FIG. 2, the rack 20 having a substantially triangular shape when viewed from above is placed in a predetermined position in the room or the like, and the display devices 25, such as liquid crystal displays, are placed at positions corresponding to the sides of the rack 20. In addition, a plurality of attendees 40 (two in the present embodiment) are seated between adjacent display devices 25, and the digital camera 1 for a TV conference described above is placed on the rack 20.

In this case, as required, a microphone 21 and a loudspeaker 22 are placed, for example, on the rack 20. In the present embodiment, a device into which the microphone 21 and the loudspeaker 22 are integrated is placed on the rack 20, and the digital camera 1 for a TV conference is then placed on the device.

Each of the display devices 25 is attached to the top of a display device stand 30 in advance in such a way that the vertical position of the display device 25 and the angle of the display screen can be adjusted. An example of a usable display device stand 30 includes a base 31 pivotable and movable in four directions, forward and rearward as well as rightward and leftward, on the floor, a vertically extendable column 32 provided on the upper side of the base 31 and standing perpendicular thereto, and angularly adjustable supporting means 33 provided at the top of the column 32. By attaching the display device 25 to the supporting means 33 of the display device stand 30 configured as described above, the vertical position of the display device 25 and the angle of the display screen can be adjusted.

The digital camera 1 for a TV conference is electrically connected, for example, to a USB port of a personal computer body 35 using a USB cable. Then, an image acquired by the digital camera 1 for a TV conference can be displayed on the display screens of the display devices 25.

By using the digital camera 1 for a TV conference to acquire an image of the attendees 40, and displaying the acquired image on the display screens of the display devices 25, the attendees 40 operates their keyboards and mouses while looking at the display screens of the display devices 25, allowing the TV conference to smoothly proceed.

In the digital camera 1 for a TV conference configured as described above according to the present embodiment, the sub-lens unit 10 having the fish-eye lens 12 attached to the front end of the main lens unit 5 provides an increased viewing angle for image acquisition of approximately 180 degrees. Therefore, by placing the digital camera 1 for a TV conference at the center of the circle along which the attendees 40 are seated, it is possible to acquire an image of all the attendees 40 and display the acquired image on the display screens of the display devices 25.

Therefore, it is possible, for example, to clearly know who is participating in the TV conference and make decisions through majority votes of the attendees on both sides remote from each other, allowing the TV conference to smoothly proceed.

Furthermore, since a commercially available digital camera (a PC camera, for example) may be combined with a commercially available fish-eye lens, a TV conference system can be built at reasonable cost.

What is claimed is:

1. A digital camera for a TV conference used in a TV conference held with a plurality of attendees to acquire an image of the plurality of attendees and operable to output the acquired image data, the camera comprising:
a camera body provided with an imaging element therein;
a main lens unit provided at the portion of the camera body that corresponds to the imaging element; and
a sub-lens unit having a wide viewing angle attached to the front end of the main lens unit.

2. The digital camera for a TV conference according to claim 1, wherein the main lens unit includes a lens barrel and at least one lens provided in the lens barrel, and the sub-lens unit is attached to the front end of the lens barrel.

3. The digital camera for a TV conference according to claim 2, wherein the sub-lens unit includes a lens barrel and a fish-eye lens provided at the front end of the lens barrel or in the lens barrel, and the lens barrel is attached to the front end of the lens barrel of the main lens unit.

4. The digital camera for a TV conference according to claim 1, wherein the main lens unit further includes a zooming mechanism that adjusts the focal length of at least one lens and a focus adjustment mechanism that adjusts the focus of the at least one lens.

5. The digital camera for a TV conference according to claim 2, wherein the main lens unit further includes a zooming mechanism that adjusts the focal length of the at least one lens and a focus adjustment mechanism that adjusts the focus of the at least one lens.

6. The digital camera for a TV conference according to claim 3, wherein the main lens unit further includes a zooming mechanism that adjusts the focal length of the at least one lens and a focus adjustment mechanism that adjusts the focus of the at least one lens.

7. The digital camera for a TV conference according to claim 1, wherein the camera body is provided with a supporting member that supports the camera body with the main lens unit facing upward.

8. The digital camera for a TV conference according to claim 2, wherein the camera body is provided with a supporting member that supports the camera body with the main lens unit facing upward.

9. The digital camera for a TV conference according to claim 3, wherein the camera body is provided with a supporting member that supports the camera body with the main lens unit facing upward.

10. The digital camera for a TV conference according to claim 4, wherein the camera body is provided with a supporting member that supports the camera body with the main lens unit facing upward.

11. The digital camera for a TV conference according to claim 5, wherein the camera body is provided with a supporting member that supports the camera body with the main lens unit facing upward.

12. The digital camera for a TV conference according to claim 6, wherein the camera body is provided with a supporting member that supports the camera body with the main lens unit facing upward.
